(19) United States
(12) Patent Application Publication
(10) Pub. No.: US 2013/0195123 A1
(43) Pub. Date: Aug. 1, 2013

(54) CLOCK RECOVERY OVER PROTECTED PACKET NETWORKS

(71) Applicants: Alon STERN, Haifa (IL); Guy Kromfnthai, Kiryal Nono (IL); Raz Korn, Hod Hashron (IL); Zir Bahak, Rinon Lezion (IL); Osnat Shasha, Holor (IL)

(72) Inventors: Alon STERN, Haifa (IL); Guy Kromfnthai, Kiryal Nono (IL); Raz Korn, Hod Hashron (IL); Zir Bahak, Rinon Lezion (IL); Osnat Shasha, Holor (IL)

(21) Appl. No.: 13/361,967

(22) Filed: Jan. 31, 2012

(51) Int. Cl. H04J 3/06

(52) U.S. Cl. 370/503

(57) ABSTRACT

A method and circuit for recovering a clock signal in a receiving station, wherein the receiving station receives packets carrying timing information” (TI) from a transmitting station over a packet switched network, the TI relating to a reference timing source located over the network. The method comprises the steps of: calculating over time, in the receiving station, a “TI Delay” variable based on a relative time difference between a timestamp assigned to a sample of a clock signal generated in the receiving station and the TI; upon detecting a Delay Deviation in the TI Delay, accumulating the Delay Deviation in an “Accumulated Deviation” variable; subtracting the Accumulated Deviation from the TI Delay; adjusting the frequency of the clock signal based on the TI Delay; and upon detecting that the Accumulated Deviation absolute value is smaller than a Zeroing Threshold, zeroing the Accumulated Deviation before subtracting it from the TI Delay.

### FIELD OF THE INVENTION

The present invention relates generally to communication networks, and particularly to methods and systems for clock recovery over packet networks.

### BACKGROUND OF THE INVENTION

Packet networks, typically Ethernet based, constitute a common infrastructure for carrying many types of data services. However, when constant bit rate streams, such as audio, video and Circuit Emulation Services (CESs), are transferred over packet networks, special means are typically applied for allowing accurate recovery of the stream source clock at the receiving station. Clock synchronization is typically required for any service and attached equipment that need accurate timing. Examples of such means, which are very commonly used in Internet Protocol (IP) networks, are Real Time Transport Protocol (RTP) and Real Time Control Protocol (RTCP), specified in IETF RFC 3550, whose content is incorporated herein by reference. A key clock recovery facility that is comprised in RTP/RTCP is a “timestamp” mechanism, which carries timing information from a source station to one or more receiving stations. It is typically assumed that the source system clock is locked on a good reference clack, such as Primary Reference Source (PRS), although other reference clocks are not excluded. Generally, clock synchronization may be needed for any data stream that relies on accurate timing, either in the same network element of the synchronization means, or in a remote equipment.

A receiving station usually controls playback of the received payload by applying the received timestamps to a local system clock that is typically derived from a Primary Reference Source (PRS). However, PRS is normally not available in remote receiving stations, such as Base Transceiver Stations (BTSs) at the edge of a Radio Access Network (RAN) backhaul network. To synchronize its system clock module, such a. remote station uses the timestamps that are received through a selected session that carries time information such as RTP or RTCP. In trying to synchronize a clock over a non-synchronized network, there is a major problem to compensate for delay variation or, in other words, to filter out network jitter affecting arriving timestamps. The delay in the network is a superposition of passive and active network factors. Passive network factors, such as fiber and cable, are usually constant physical factors and their contribution to delay variation is practically negligible. However, active network elements, such as switches and routers, might introduce significantly variable accumulated delay, namely jitter, that must be filtered out.

Several approaches are known in the art for precise timestamp-based clock recovery in a switched packet network. An advanced method and system for mitigating the adverse effect of associated jitter on timestamp-based clock recovery circuits was suggested in our previous U.S. Pat. No. 7,664,118, the disclosure of which is incorporated herein by reference. In this publication, a regression procedure is applied to detect latency change and estimate latency change value.

However, the clock recovery techniques that are known in the art might be vulnerable to temporary path reconfigurations due to failures or other singular network events. Thus, there is a need for improved clock recovery circuits that minimize vulnerability to such singular network events.

### SUMMARY OF THE INVENTION

Accordingly, it is a principal object of the invention to overcome disadvantages associated with existing clock recovery techniques and provide an improved clock recovery technique which minimizes vulnerability to singular network events such as temporary path reconfigurations.

In accordance with an embodiment of the present invention, there is provided a method and circuit of recovering a clock signal in a receiving station, wherein the receiving station receives packets carrying “Timing Information” (TI) from a transmitting station over a packet switched network, the TI relating to a reference timing source located over the network, the method comprising the steps of: calculating over time, in the receiving station, a “TI Delay” variable based on a time difference between a timestamp assigned to a sample of a clock signal generated in the receiving station and the TI; upon detecting a Delay Deviation in the TI Delay, accumulating the Delay Deviation in an “Accumulated Deviation” variable; subtracting the Accumulated Deviation from the TI Delay; adjusting the frequency of the clock signal based on the TI Delay; and upon detecting that the Accumulated Deviation absolute value is smaller than a Zeroing Threshold, zeroing the Accumulated Deviation before subtracting it from the TI Delay.

In an embodiment of the present invention, a source station in a packet switched network transmits packets carrying Timing Information (TI) to one or more receiving stations. The network is typically Ethernet based, however the disclosed techniques can be applied to any type of packet based network, such as Data-Over-Cable Service Interface Specifications (DOCSIS). The TI is typically, though not necessarily, a timestamp. The terms “timestamp” and “TI” relate herein to either one message or to a series of messages of each type. In a typical embodiment TI comprises RTP or RTCP timestamps.

In one embodiment the packets carrying the TI typically carry also constant bit rate data payload. In another embodiment the packets carry mainly control information, such as timing. The TI reflects a frequency of a reference timing source that is coupled to the transmitting station. and. may also contain phase and/or time of day information. In one embodiment the reference timing source is a Primary Reference Source (PRS); in other embodiments the reference timing source is less accurate than a PRS.

An embodiment of the present invention comprises a Clock Recovery (CR) circuit, which resides in stations of the network that receive the TI. Such a CR circuit typically comprises a clock module that outputs a clock signal, and a synchronization mechanism that adjusts the clock module to be synchronized with the received TI. Thereby, the clock module can comply with wander requirements that are recommended by international standards of timing, such as International Telecommunication Union (ITU) G.823, G.824 or G.8261. Embodiments of the above synchronization are described, for example, in U.S. Pat. No. 7,664,118, referenced above.

The synchronization is based on filtering out estimated network latency variations from a measured time delay over a network route that leads the TI from the transmitting station to the CR circuit, and then adjusting the frequency of the clock module in the CR circuit to track the received TI. The CR circuit also filters out abrupt changes in the estimated network latency, hereinafter denoted as “Delay Deviations”, which may result from switching events in the network that cause changes in the network route. Such switching events include, but are not limited to, protection switching, link upgrades, station upgrades, temporary traffic loads etc.

In an embodiment, the CR circuit further calculates an accumulation of a recent series of consecutive Delay Deviations as “accumulated deviation”. When the accumulation goes down to a sufficiently small value, these recent Delay Deviations are interpreted as having been caused by revertive switching events, i.e. the route between the transmitting station and the CR circuit has resumed its original network path prior to the first Delay Deviation in the series. In this case, the CR introduces a correction to the regular frequency adjustment procedure, as detailed hereinafter. This correction statistically reduces latency estimation errors that might be induced in the clock signal by revertive switching events in the network.

In other embodiments of the present invention the above clock recovery method further comprises conditioning zeroing the Accumulated Deviation on detecting that the number of the accumulated Delay Deviations is even, provided that the network has a ring topology.

In other embodiments of the above clock recovery method, detecting the Delay Deviation comprises detecting minimum network latency points over time and applying regression procedure to the minimum network latency points.

In other embodiments of the present invention the above clock recovery method further comprises calculating a quality of the TI Delay and determining the Zeroing Threshold dynamically, based on the quality of the TI Delay.

### BRIEF DESCRIPTION OF THE DRAWINGS

The present invention will be more fully understood from the following detailed description of the embodiments thereof, taken together with the drawings in which:

FIG. 1A is a network diagram that schematically illustrates a switched packet network that comprises a clock recovery circuit, in accordance with an embodiment of the present invention;

FIG. 1B is a block diagram that schematically illustrates a clock recovery circuit, in accordance with an embodiment of the present invention;

FIGS. 2A, 2B and 2C are timing diagrams that schematically illustrate reducing network latency estimation errors that might result from revertive network switching events in embodiments of the present invention; and

FIG. 3 is a flowchart that schematically illustrates a method for recovering clock, in accordance with an embodiment of the present invention;

### DETAILED DESCRIPTION OF EMBODIMENTS

Embodiments of the present invention provide improved methods and circuits of clock recovery. In particular, the disclosed techniques help reducing clock tracking errors that might occur due to switching events in packet switched networks.

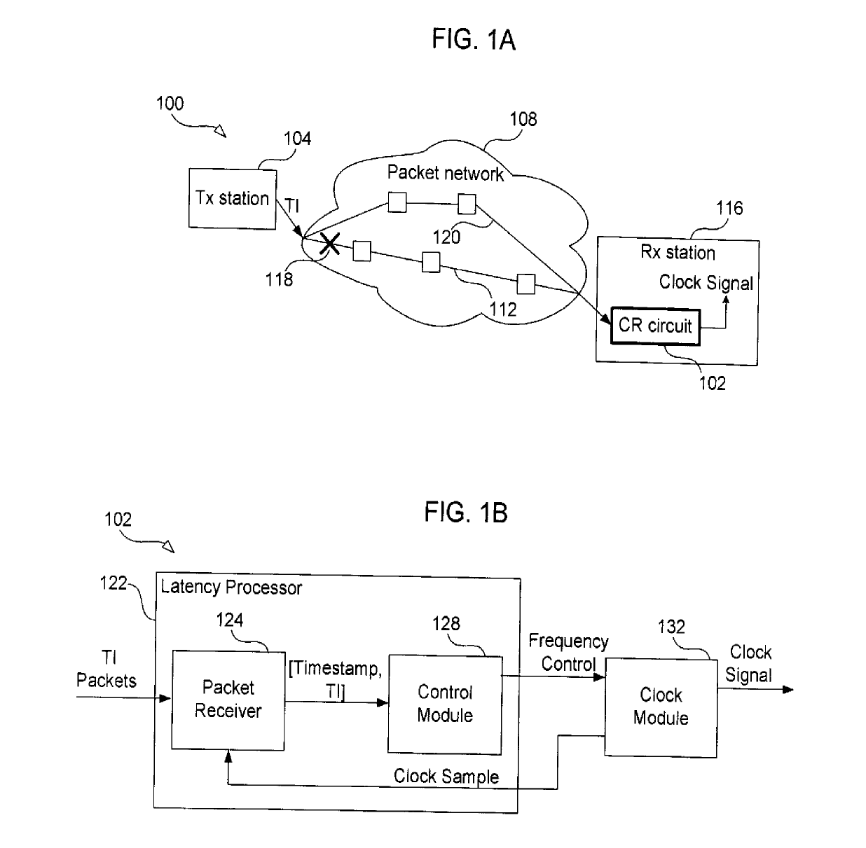

Referring now to FIG. 1A there is shown a network diagram 100 that comprises a CR circuit 102, constructed and operated in accordance with an embodiment of the present invention. A transmitting station 104 is connected to a switched packet network 108 and transmits packets carrying Timing Information, denoted TI, through a network path 112. The TI arrives, after a certain network latency over path 112, at a receiving station 116 which comprises CR circuit 102. CR circuit 102 locks a local clock signal at its output on the received TI, as hereinafter described. Upon occurrence of a failure 118 in path 112, network 108 shifts the traffic of path 112, including the TI, to an alternative network path 120. Consequently, CR circuit 102 now receives the TI in a typically different latency than that of path 112.

Path failure 118 is depicted in FIG. 1 as a representative example for various triggers of network switching events, as mentioned, above. In an embodiment, it is assumed that after the cause of the switching event is over, the network would revert the traffic between stations 104 and 116 to its original route, i.e. path 112. Consequently the TI latency through the network would resume its original value, besides latency variations such as jitter.

In one embodiment, receiving station 116 also comprises circuits for processing data that it receives and transmits over the network, in particular, constant bit rate data. In this case receiving station 116 uses the clock signal for this processing. In another embodiment, receiving station 116 comprises mainly control and/or timing functions, and outputs the clock signal to adjacent and/or to remote stations.

FIG. 1B is a block diagram that schematically illustrates CR circuit 102, in accordance with an embodiment of the present invention. A latency processor 122 processes the TI carrying packets that arrive from network 108 and controls accordingly a clock module 132, which outputs the above-mentioned clock signal. A packet receiver 124 within latency processor 122 first extracts the TI from the packets carrying it and transfers the TI to a Control Module 128, denoted CM. Packet receiver 124 also accepts from clock module 132 a sample of the clock signal, denoted as clock sample. The packet receiver assigns the clock sample a timestamp upon receiving each TI and attaches this timestamp to each TI that it transfers to the CM.

CM 128 calculates, for each pair of variables (timestamp, TI) that it accepts from packet receiver 124, a relative latency estimation [timestamp minus TI]. CM 128 then estimates the network latency variations over time by filtering out network jitter from the above differences as described, for example, in above-mentioned U.S. Pat. No. 7,664,118. This relative latency estimation is denoted “TI delay”. The CM then produces a frequency control signal thereof. Clock module 132 receives the frequency control signal from CM 128 and adjusts the frequency of the clock signal accordingly. In one embodiment, the clock sample is taken from a clock source, such as an Oven Controlled Crystal Oscillator (OCXO), within clock module 132. In another embodiment, the clock sample is taken from the clock signal at the clock module output. Additional sources are also applicable, such as Sync-E, TDM circuit, etc.

In an embodiment, CM 128 typically comprises a programmable processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

The arrow directions in FIGS. 1A and 1B represent the transfer direction of the main information elements that were mentioned above, although information transfer in opposite directions may also take place. The above description has focused on the specific elements of CR circuit 102 that are essential for understanding certain features of the disclosed techniques. Conventional elements of CR circuit 102 that are not needed for this understanding have been omitted from FIG. 1B for the sake of simplicity but will be apparent to persons of ordinary skill in the art.

The configurations shown in FIGS. 1A and 1B are example configurations, which are chosen purely for the sake of conceptual clarity. In alternative embodiments, any other suitable configurations can also be used.

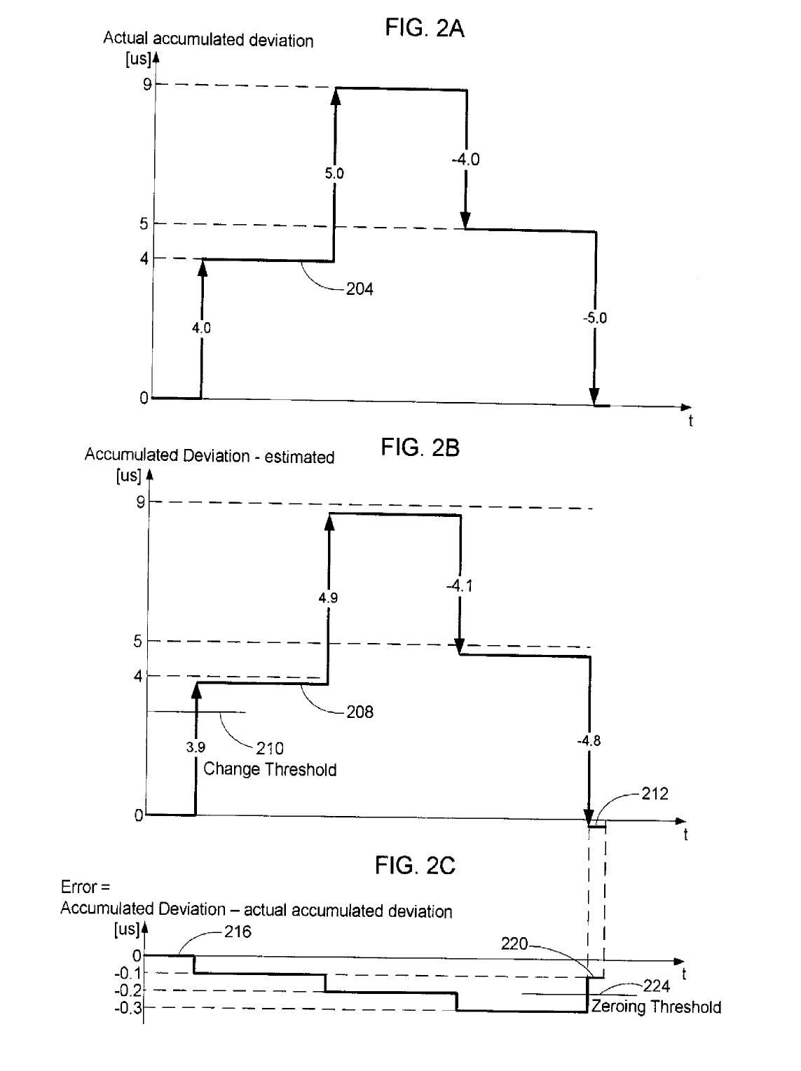

FIGS. 2A, 2B and 20 are timing diagrams that schematically illustrate reducing network latency estimation errors that might result from revertive network switching events in embodiments of the present invention. All three diagrams comprise a series of three consecutive Delay Deviations resulting from three respective network switching events. The network switching events cause rerouting of the TI packets, however, at the last switching event the route between the transmitting and receiving stations resume its original path, denoted 112 in FIG. 1A.

Referring now to FIG. 2A, there is shown a graph of a “actual accumulated deviation” variable, denoted 204, which is an accumulation over time of abrupt network delay changes that actually resulted from the aforementioned three switching events. In particular, graph 204 comprises delay changes of +4 μsec, +5 μsec, −4 μsec and −5 μsec.

FIG. 2B illustrates an example of an Accumulated Deviation, denoted 208, which is a version of graph 204, as estimated by CM 128 while calculating and analyzing over time the TI delay. In particular, the CM estimates the above actual delay changes as Delay Deviations of +3.9 μsec, +4.9 μsec, −3.1 μsec and −4.8 μsec. Consequently the estimated Accumulated Deviation reaches an erroneous value 212 of −0.1 μsec instead of 0 μsec. In an embodiment, CM 128 does not interpret delay changes that do not exceed a change threshold 210 as Delay Deviations, and handles them as described, for example, in U.S. Pat. No. 7,664,118, referenced above. In some embodiments, detecting Delay Deviations comprises detecting minimum network latency points over time and applying a regression procedure to the minimum network latency points, as also described in above-mentioned U.S. Pat. No. 7,664,118.

FIG. 2C illustrates a resulting accumulated deviation error graph 216, obtained by subtracting estimated graph 208 from actual graph 204. A graph value 220 of −0.1 μsec depicts the resulting estimation error immediately after the four switching events. The value of this error is equal to Accumulated Deviation value 212 in FIG. 2B. If error 220 is smaller than a Zeroing Threshold 224, as actually illustrated in FIG. 2C, the CM would subtract this error from the Accumulated Deviation, thus zeroing it, while calculating TI Delay, as described hereinafter, thereby achieving more accurate network latency estimation. In some embodiments, wherein the topology of network 108 is ring based, each network switching event is typically revertive within the ring in which it takes place. Consequently, CM 128 performs the above-mentioned zeroing operation of the Accumulated Deviation, based on a condition in which the number of recent consecutive network switching events is an even number.

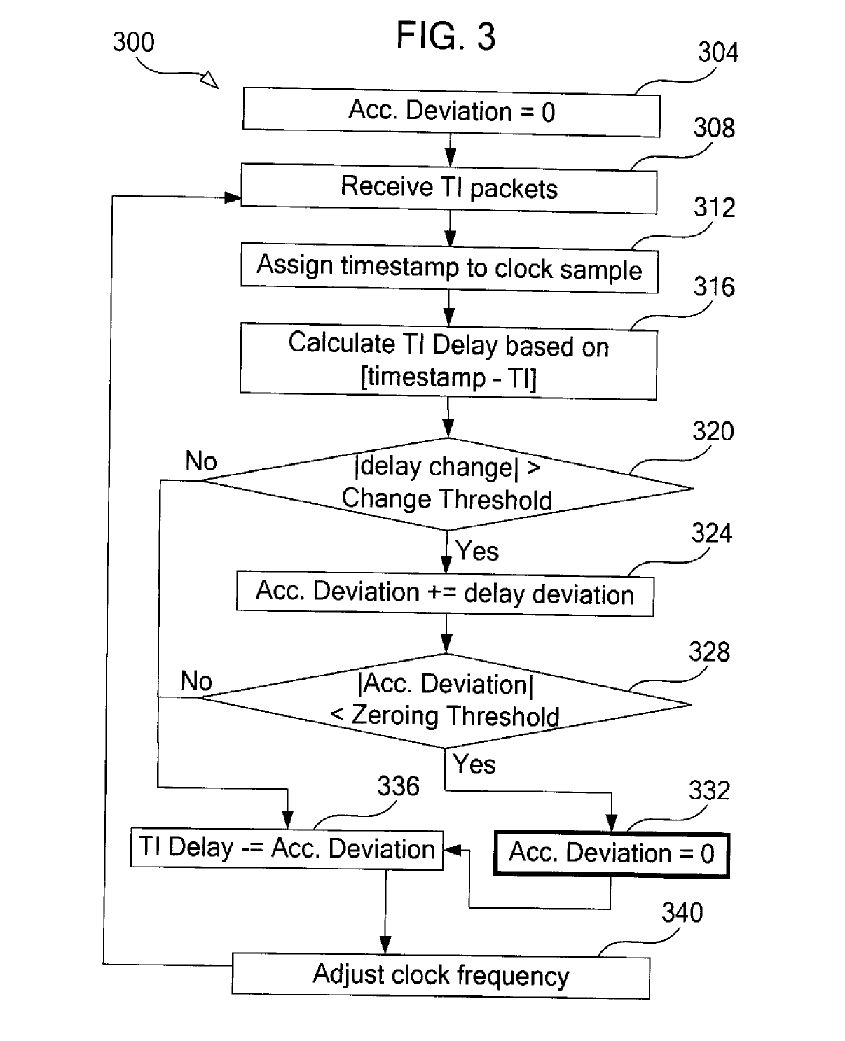

FIG. 3 shows a flowchart 300, which schematically illustrates a method for recovering clock, in accordance with an embodiment of the present invention. The method begins with a reset step 304 wherein the CM sets Accumulated Deviation 208 to zero. In a receiving step 308 packet receiver 124 receives TI carrying packets from network 108. In an assigning step 312, packet receiver 122 assigns a timestamp to the clock sample upon receiving each TI. In a calculating step 316 CM 128 calculates over time the differences [timestamp minus TI], and estimates the relative network latency variable TI delay thereof by filtering out network jitter over time, as described for example in U.S. Pat. No. 7,664,118, referenced above. In a comparing step 320 the CM examines changes in TI Delay, denoted “delay changes”. In particular the CM is waiting for detecting an abrupt delay change in TI Delay whose absolute value is larger than a given Change Threshold. Such a sufficiently large abrupt delay change was denoted above as “Delay Deviation”. Reliable methods for evaluating delay change and Delay Deviations, sometimes also denoted “latency deviations”, are provided in U.S. Pat. No. 7,664,118, referenced above.

As long as |delay change|<Change Threshold, flowchart 300 proceeds to a correcting step 336, wherein the CM always subtracts the current Accumulated Deviation from the TI Delay and produces the frequency control signal thereof. In an adjusting step 340 that follows, clock module 132 uses the frequency control signal that it receives from the CM for adjusting the frequency of the clock signal. Once a Delay Deviation is detected in comparing step 320, the flowchart proceeds to an accumulating step 324, wherein the CM accumulates the detected Delay Deviation in Accumulated Deviation variable 208. In a comparing step 328 the CM compares the Accumulated Deviation absolute value with Zeroing Threshold 224.

If the Accumulated Deviation is not sufficiently small the method proceeds to previously discussed step 336. Upon detecting a smaller Accumulated Deviation value than the Zeroing Threshold, the CM (zeroes) the Accumulated Deviation, in a reset step 332, before proceeding to correcting step 336. Reset step 332 actually filters out an estimation error that might have occurred due to consecutive Delay Deviation events. Following adjusting step 340 the method resumes at receiving step 308.

In an embodiment, CM 128 determines Zeroing Threshold 224 dynamically, based on assessing TI Delay quality. For example, a noisy TI delay would lead to a higher Zeroing Threshold. In some embodiments, the Accumulated Deviation value prior to any detected Delay Deviation may constitute a starting point for a nested execution of flowchart 300.

The flowchart shown in FIG. 3 is an example flowchart, which was chosen purely for the sake of conceptual clarity. In alternative embodiments, any other suitable flowchart can also be used for illustrating the disclosed method. In particular, any variable equivalent to the TI delay can be used in the described or any equivalent method. Method steps that are not mandatory for understanding the disclosed techniques were omitted from FIG. 3 for the sake of clarity.

Although the embodiments described herein mainly address clock recovery in packet switched networks, the methods and systems exemplified by these embodiments can also be used in other time synchronization applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method of recovering a clock signal in a receiving station, wherein said receiving station receives packets carrying timing information (TI) from a transmitting station over a packet switched network, said TI relating to a reference timing source located over the network, said method comprising the steps of:
(a) calculating, in the receiving station, a TI delay variable based on a relative time difference between a timestamp assigned to a sample of a clock signal generated in the receiving station and said TI;
(b) upon detecting a delay deviation in the TI delay, accumulating said delay deviation in an accumulated deviation variable;
(c) subtracting said accumulated deviation from the TI delay;
(d) adjusting the frequency of the clock signal based on the TI delay; and
(e) upon detecting that the accumulated deviation absolute value is smaller than a Zeroing Threshold, zeroing the accumulated deviation before subtracting it from the TI delay, thereby reducing network latency estimation errors induced by revertive switching events in the network.

2. The method of claim 1, further comprising conditioning zeroing operation of the accumulated deviation on detecting that the number of the accumulated delay deviations is an even number, provided that the network has a ring topology.

3. The method of claim 1, wherein detecting the delay deviation comprises detecting minimum network latency points and applying a regression procedure to said minimum network latency points.

4. The method of claim 1, further comprising calculating a quality of the TI delay and determining the Zeroing Threshold dynamically, based on said quality of the TI delay.

5. A clock recovery circuit, for recovering a clock signal in a receiving station, wherein the receiving station receives packets carrying timing information (TI) from a transmitting station over a packet switched network, said TI relating to a reference timing source located over the network, said recovery circuit comprising:
a clock module, configured to output a clock signal; and
a Latency Processor, configured to perform the steps of:
(a) assigning a timestamp to a sample of said clock signal upon receiving said TI in said receiving station;
(b) calculating a TI delay variable based on a relative time difference between said timestamp and said TI;
(c) upon detecting a delay deviation in the TI delay, accumulating said delay deviation in an accumulated deviation variable;
(d) subtracting said accumulated deviation from the TI delay;
(e) adjusting the frequency of the clock signal based on the TI delay; and
(f) upon detecting that the accumulated deviation absolute value is smaller than a Zeroing Threshold, zeroing the accumulated deviation before subtracting it from the TI delay, thereby reducing network latency estimation errors induced by revertive switching events in the network.

6. The clock recovery circuit of claim 5, wherein the Latency Processor is further configured to condition zeroing operation of the accumulated deviation on detecting that the number of the accumulated delay deviations is an even number, provided that the network has a ring topology.

7. The clock recovery circuit of claim 5, wherein detecting the delay deviation comprises detecting minimum network latency points and applying a regression procedure to said minimum network latency points.

8. The clock recovery circuit of claim 5, wherein the Latency Processor is further configured calculate a quality of the TI delay and to determine the Zeroing Threshold dynamically, based on said quality of the TI delay.
